(19) United States
(12) Patent Application Publication
(10) Pub. No.: US 2023/0163832 A1
(43) Pub. Date: May 25, 2023

(54) RELIEF SHIP

(71) Applicant: KAWASAKI JUKOGYO KABUSHIKI KAISHA, Kobe-shi, Hyogo (JP)

(72) Inventors: Tetsuya KUBOTA, Kobe-shi (JP); Susumu IKEDA, Kobe-shi (JP)

(73) Assignee: KAWASAKI JUKOGYO KABUSHIKI KAISHA, Kobe-shi, Hyogo (JP)

(21) Appl. No.: 17/917,371

(22) PCT Filed: Apr. 16, 2021
(86) PCT No.: PCT/JP2021/015704

§ 371 Date: Oct. 6, 2022

(30) Foreign Application Priority Data
Apr. 22, 2020 (JP) 2020-076340

(51) Int. Cl. H04B 7/155; H04B 7/185

(52) U.S. Cl. CPC H04B 7/155; H04B 7/185

(57) ABSTRACT

A relief ship includes: a hull; an on-board relay station mounted on the hull to create a first wireless communication area on and/or around the hull; at least one mover mounted on the hull and movable to a place away from the hull; and a mobile relay station mounted on the mover. The on-board relay station is configured to receive a radio wave transmitted from a ground base station and transmit the radio wave to a wireless terminal located in the first wireless communication area and configured to receive a radio wave transmitted from the wireless terminal located in the first wireless communication area and transmit the radio wave to the ground base station. The mobile relay station is configured to relay radio waves between the on-board relay station and the ground base station.

### TECHNICAL FIELD

The present disclosure relates to a relief ship dispatched to a coastal disaster site or the like.

### BACKGROUND ART

A conventionally-proposed approach to a communication failure in a wireless communication network is to dispatch a mobile relay station for relaying communication between a base station and a wireless terminal to the area where the failure has occurred and thereby improve the communication situation. Patent Literatures 1 and 2 disclose such kinds of technologies.

In the wireless communication system of Patent Literature 1, radio waves sent from a push server connected to a wireless communication network are transmitted to a wireless terminal through a communication satellite and a wireless communicator mounted on an aircraft (or a ship). The push server sends the flight schedule of the aircraft (in particular, information related to the time period during which the wireless terminal can perform communication) to the wireless terminal since the communication-enabled area created by the wireless communicator moves in accordance with the flight schedule of the aircraft

In the communication system of Patent Literature 2, an airborne communication relay such as HAPS is connected to a core network of a mobile communication network via a feeder station that is a relay station located on the ground or at sea. The airborne communication relay is located in a given altitude range and creates a three-dimensional wireless communication area in a cell creation target region defined at a given altitude.

There are ships (hospital ships) configured to serve the function of hospitals to deliver medical care to sick or insured people at sites affected by famines or serious disasters. The hospital ships are known to include not only common pieces of ship equipment but also medical installations such as patient bedrooms, examination rooms, treatment rooms, surgery rooms, and ICUs and to be furnished with a variety of medical devices such as testing devices, surgical devices, X-ray devices, and computerized tomography scanning devices. Some recently-developed hospital ships are configured to allow doctors to make remote examinations or perform remote surgery using remotely-controlled surgical robots.

### CITATION LIST

### Patent Literature

PTL 1: Japanese Laid-Open Patent Application Publication No. 2017-169115

PTL 2: Japanese Laid-Open Patent Application Publication No. 2019-47467

### SUMMARY OF INVENTION

### Technical Problem

At a disaster site, it is envisaged that a good communication situation cannot be achieved because of, for example, damage to the communication infrastructure. There is also a possibility that the capacity of the communication infrastructure is insufficient to meet momentarily and rapidly increased communication demand.

The present disclosure addresses the above circumstances, and an object of the present disclosure is to propose a relief ship (e.g., a hospital ship) dispatched to a coastal disaster site or the like, the relief ship being adapted to improve the communication situation at the disaster site or the like.

### Solution to Problem

A relief ship according to one aspect of the present disclosure includes:

a hull;

an on-board relay station mounted on the hull to create a first wireless communication area on and/or around the hull;

at least one mover mounted on the hull and movable to a place away from the hull; and

a mobile relay station mounted on the mover, wherein

the on-board relay station is configured to receive a radio wave transmitted from a ground base station and transmit the radio wave to a wireless terminal located in the first wireless communication area and configured to receive a radio wave transmitted from the wireless terminal located in the first wireless communication area and transmit the radio wave to the ground base station, and

the mobile relay station is configured to relay radio waves between the on-board relay station and the ground base station.

The relief ship with the above configuration is anchored off the coast of a disaster site where a wireless communication installation has been damaged, and the mover, for which the relief ship is a base, is moved to a land, sky, or sea area located between the ground base station and the on-board relay station. Thus, the ground base station located away from the disaster site and the on-board relay station can exchange radio waves with each other via the mobile relay station. This makes it possible to deliver stable radio waves to the wireless terminal located in the first wireless communication area and improve the communication situation in the first wireless communication area.

A relief ship according to another aspect of the present disclosure includes:

a hull;

an on-board relay station mounted on the hull;

at least one mover mounted on the hull and movable to a place away from the hull; and

a mobile relay station mounted on the mover, wherein

the at least one mover includes a first mover on which a first mobile relay station is mounted,

the first mobile relay station is configured to create a second wireless communication area around the first mover, configured to receive a radio wave transmitted from a ground base station and transmit the radio wave to a wireless terminal located in the second wireless communication area, and configured to receive a radio wave transmitted from the wireless terminal located in the second wireless communication area and transmit the radio wave to the ground base station, and

the on-board relay station is configured to relay radio waves between the ground base station and the first mobile relay station.

The relief ship with the above configuration is anchored off the coast of a disaster site where a wireless communication installation has been damaged, and the first mover, for which the relief ship is a base, is moved to the disaster site. Thus, the ground base station located away from the disaster site and the first mobile relay station can exchange radio waves with each other via the on-board relay station. This makes it possible to deliver stable radio waves to the wireless terminal located in the second wireless communication area and improve the communication situation in the second wireless communication area.

### Advantageous Effects of Invention

The present disclosure can propose a relief ship (e.g., a hospital ship) dispatched to a coastal disaster site or the like, the relief ship being adapted to improve the communication situation at the disaster site or the like.

### BRIEF DESCRIPTION OF DRAWINGS

FIG. 1 is a side view showing an overall configuration of a relief ship according to an exemplary embodiment of the present disclosure.

FIG. 2 illustrates a first communication support system built for the relief ship.

FIG. 3 shows the relief ship dispatched to a disaster site.

FIG. 4 illustrates a second communication support system built for the relief ship.

FIG. 5 illustrates a variant of the second communication support system built for the relief ship.

FIG. 6 shows the relief ship dispatched to a disaster site.

### DESCRIPTION OF EMBODIMENTS

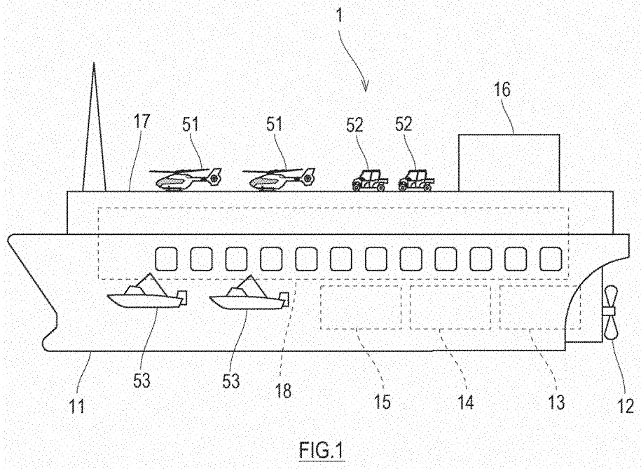

FIG. 1 is a side view showing an overall configuration of a relief ship 1 according to an exemplary embodiment of the present disclosure. The following description assumes that the present disclosure is applied to a hospital ship which is one aspect of the relief ship 1. The relief ship 1 is not limited to the hospital ship and may be a ship used for relief activities other than medical activities, such as transfer of relief supplies.

Like a common ship, the relief ship 1 of FIG. 1 includes a hull 11, a propeller 12, a main engine 13, an electricity generator 14, and a storage battery 15. The main engine 13 generates drive power for the propeller 12. The main engine 13 may be a diesel engine, a turbine engine, an electric propulsion engine, or a combination of these engines. The electricity generator 14 generates electricity using drive power received from an engine for electricity generation (not shown), and supplies the generated electricity to the inboard electrical system and the storage battery 15. The main engine 13 may function also as the engine for electricity generation.

Like a common ship, the relief ship 1 includes various nautical instruments. The nautical instruments include, for example, a chronometer, a gyrocompass, a ship speed indicator, a wind direction/speed indicator, a bathometer, a radar, and a GPS receiver. The GPS receiver receives a signal from a GPS satellite (not shown) flying over the ship and determines the current position of the relief ship 1.

A bridge 16 is located at the top of the relief ship 1. Inside the bridge 16 there is a control cabin, which includes pieces of equipment for maneuvering of the relief ship 1. A flight deck 17 is located at the top of the relief ship 1.

The relief ship 1 is equipped with at least one helicopter 51, wheeled vehicle 52, or small boat 53. The helicopters 51 and the wheeled vehicles 52 are located on the flight deck 17. The small boats 53 are located on a lateral side of the hull 11. The helicopters 51, wheeled vehicles 52, and small boats 53 are used primarily for transfer of goods and personnel from the relief ship 1 to a disaster site (or vice versa). The helicopters 51, wheeled vehicles 52, and small boats 53 may include devices for emergency medical care or emergency transfer to contribute to rescue or relief activities. At least one of the helicopters 51 may be an emergency medical helicopter.

The relief ship 1 according to the present embodiment is a hospital ship and includes installations that enable the relief ship 1 to serve the function of a hospital. The relief ship 1 includes medical installations 18 such as a patient bedroom, an examination room, and a surgery room. The examination room is equipped with a remote examination device to allow a doctor on the ground to make a remote examination. The remote examination device includes, for example, a patient interface and a communicator. The patient interface can be constructed of a display, a microphone, a speaker, and any other suitable component. The surgery room is equipped with a patient-side system of a surgical robot system to allow a doctor on the ground to perform remote surgery. The patient-side system can be constructed, for example, of a remotely-controlled robot arm, a robot controller, a monitor, and a communicator.

The installations of the relief ship 1 are not limited to those described above. The relief ship 1 desirably includes accommodations, storage installations for foodstuffs and other goods, and lifeline installations such as that for electricity generation, in addition to the medical installations 18. This makes it possible to supply water and electricity and continue relief activities for a relatively long period of time independently of the situation of the disaster site or other factors. It is desirable for the relief ship 1 to further include a storage installation for storage of relief supplies. This makes it possible to deliver the relief supplies from the relief ship 1 to a disaster site or any other destination using movers M (helicopters 51, wheeled vehicles 52, and small boats 53) mounted on the relief ship 1.

The relief ship 1 configured as described above includes a communication support system that supports establishment of a temporary wireless communication network. The communication support system is at least one of first and second communication support systems 100A and 100B which will be described hereinafter.

[First Communication Support System 100A]

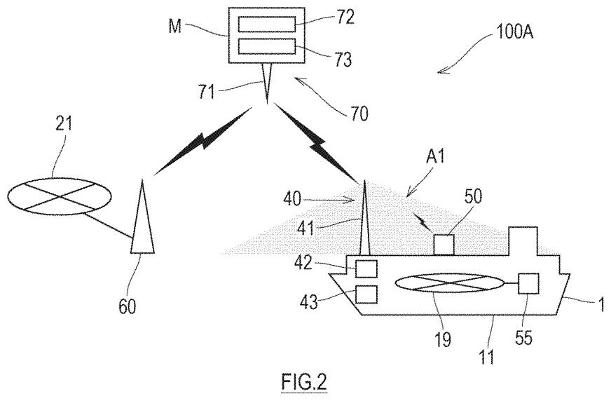

The first communication support system 100A will be described first. As shown in FIG. 2, the first communication support system 100A includes an on-board relay station 40 mounted on the hull 11 of the relief ship 1, at least one mover M mounted on the hull 11, and a mobile relay station 70 mounted on the mover M. The mover M may be any one of the helicopters 51, wheeled vehicles 52, and small boats 53.

The on-board relay station 40 includes an antenna 41, a relay 42, and an electricity feeder 43. The relay 42 includes a receiving amplifier, a transmitting amplifier, a modulator/demodulator, a switcher, a GPS receiver, and a network controller. The on-board relay station 40 receives radio waves emitted by a ground base station 60 and emits the radio waves to wireless terminals 50 located on and/or around the ship. The on-board relay station 40 receives radio waves emitted by the wireless terminals 50 located on and/or around the ship and retransmits (forwards) the radio waves to the ground base station 60. The radio waves emitted or retransmitted from the on-board relay station 40 may be amplified, modulated, or demodulated to higher levels or outputs. A first wireless communication area A1 (cell) where wireless communication is enabled is created on and/or around the hull 11 by the on-board relay station 40.

The on-board relay station 40 is connected to a wired communication network 19 located in the relief ship 1. The on-board relay station 40 can perform radio wave/signal conversion and exchange signals with inboard wired terminals 55 connected to the wired communication network 19. The inboard wired terminals 55 may include, for example, the above-mentioned remote examination device, the above-mentioned surgical robot system (patient-side system), and information instruments located in the ship.

The mobile relay station 70 includes an antenna 71, a relay 72, and an electricity feeder 73. The relay 72 includes a receiving amplifier, a transmitting amplifier, a modulator/demodulator, and a controller. The mobile relay station 70 relays radio waves between the on-board relay station 40 and the ground base station 60. That is, the mobile relay station 70 receives radio waves from the ground base station 60 and retransmits the radio waves to the on-board relay station 40, and receives radio waves from the on-board relay station 40 and retransmits the radio waves to the ground base station 60. The radio waves retransmitted from the mobile relay station 70 may be amplified to higher levels or outputs.

The relief ship 1 described above includes: a hull 11; an on-board relay station 40 mounted on the hull 11 to create a first wireless communication area A1 on and/or around the hull 11; at least one mover M mounted on the hull 11 and movable to a place away from the hull 11; and a mobile relay station 70 mounted on the mover M. The on-board relay station 40 is configured to receive a radio wave transmitted from a ground base station 60 and transmit the radio wave to a wireless terminal 50 located in the first wireless communication area A1 and configured to receive a radio wave transmitted from the wireless terminal 50 located in the first wireless communication area A1 and transmit the radio wave to the ground base station 60. The mobile relay station 70 is configured to relay radio waves between the on-board relay station 40 and the ground base station 60.

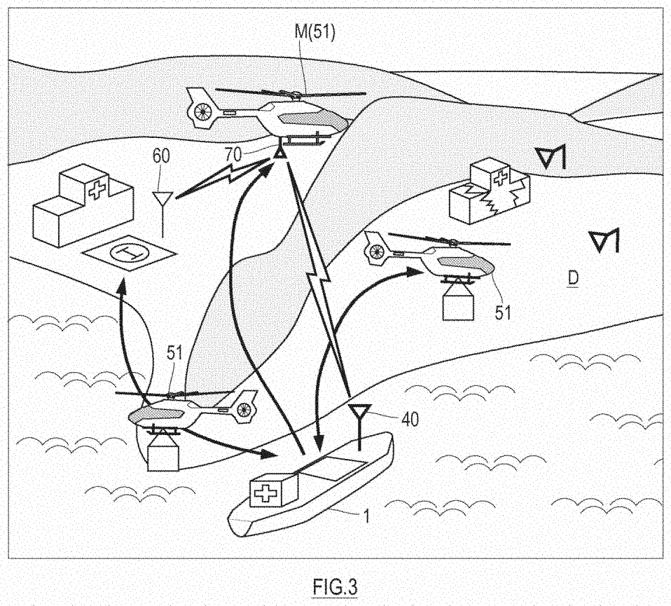

The relief ship 1 including the first communication support system 100A configured as described above is dispatched to, for example, a coastal region affected by a tsunami or an earthquake. In the event that overland routes to a disaster site are blocked due to the natural disaster or any other reason, it is effective to approach the disaster site from the sea by means of a ship in order to quickly take emergency disaster countermeasures such as rescue of injured people. In the example shown in FIG. 3, the relief ship 1 is at anchor off the coast of the disaster site D. At the disaster site D, the local communication infrastructure has been damaged, and the wireless communication function has been impaired. To address this situation, the mover M, for which the relief ship 1 is a base, is moved to a land, sky, or sea area located between a well-functioning ground base station 60 in the vicinity of the disaster site D and the on-board relay station 40 of the relief ship 1. In the example shown in FIG. 3, the mover M is the helicopter 51. The mover M is not limited to the helicopter 51 and may be the wheeled vehicle 52 or small boat 53 for which the relief ship 1 is a base. There may be two or more mobile relay stations 70 that perform a relay function between the ground base station 60 and the on-board relay station 40. In this case, radio waves are exchanged between the mobile relay stations 70.

The ground base station 60 located away from the disaster site D and the on-board relay station 40 can exchange radio waves with each other through the mobile relay station 70. This makes it possible to deliver stable radio waves to the wireless terminal 50 located in the first wireless communication area A1 and improve the communication situation in the first wireless communication area A1.

The on-board relay station 40 described above may be connected to a wired communication network 19 located in the hull 11 and configured to exchange signals with a wired terminal 55 connected to the wired communication network 19. When being at anchor off the coast of the disaster site D with a damaged communication infrastructure, the relief ship 1 can receive stable radio waves from the ground base station 60 at a high speed, in a large volume, and with a small delay. Such a configuration is beneficial especially to hospital ships adapted for remote examinations and remote surgery like the relief ship 1 according to the present embodiment.

[Second Communication Support System 100B]

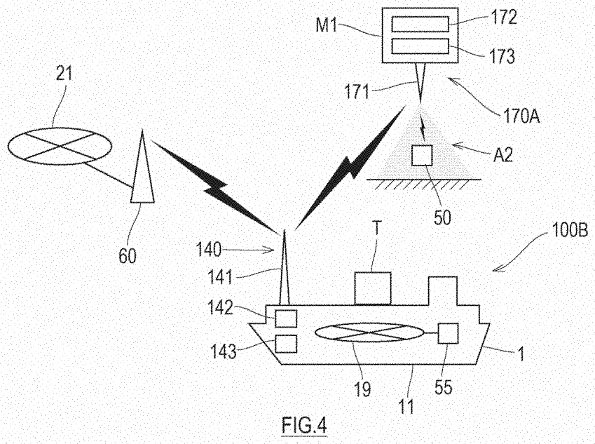

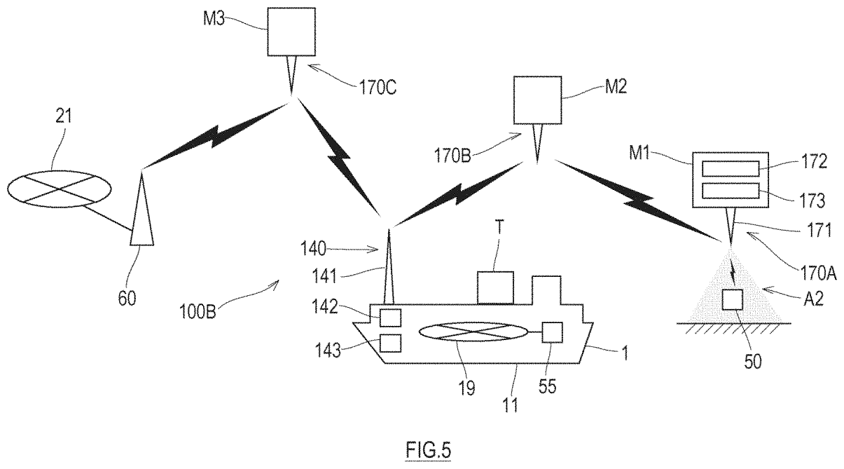

Next, the second communication support system 100B will be described. As shown in FIGS. 4 and 5, the second communication support system 100B includes an on-board relay station 140 mounted on the hull 11 of the relief ship 1, at least one mover M1, M2, or M3 mounted on the hull 11, and a mobile relay station 170A, 170B, or 170C mounted on the mover M1, M2, or M3. The mover M1, M2, or M3 may be any one of the helicopters 51, wheeled vehicles 52, and small boats 53.

As shown in FIG. 4, the at least one mover M1, M2, or M3 includes a first mover M1 on which a first mobile relay station 170A is mounted. The first mobile relay station 170A includes an antenna 171, a relay 172, and an electricity feeder 173. The relay 172 includes a receiving amplifier, a transmitting amplifier, a modulator/demodulator, a switcher, a GPS receiver, and a controller. The first mobile relay station 170A receives radio waves emitted by the ground base station 60 and emits the radio waves to the wireless terminals 50 located around the first mover M1. The first mobile relay station 170A receives radio waves emitted by the wireless terminals 50 located around the first mover M1 and retransmits the radio waves to the ground base station 60. The radio waves emitted or retransmitted from the first mobile relay station 170A may be amplified, modulated, or demodulated to higher levels or outputs. A second wireless communication area A2 (cell) where wireless communication is enabled is created around the first mover M1 by the first mobile relay station 170A.

The on-board relay station 140 includes an antenna 141, a relay 142, and an electricity feeder 143. The relay 142 includes a receiving amplifier, a transmitting amplifier, a modulator/demodulator, and a network controller. The on-board relay station 140 relays radio waves between the first mobile relay station 170A and the ground base station 60. That is, the on-board relay station 140 receives radio waves from the ground base station 60 and retransmits the radio waves to the first mobile relay station 170A, and receives radio waves from the first mobile relay station 170A and retransmits the radio waves to the ground base station 60. The radio waves retransmitted from the on-board relay station 140 may be amplified to higher levels or outputs. As in the first communication support system 100A, the on-board relay station 140 may be connected to the wired communication network 19.

As shown in FIG. 5, the at least one mover M1, M2, or M3 may include a second mover M2 on which a second mobile relay station 170B is mounted. The second mobile relay station 170B relays radio waves between the on-board relay station 140 and the first mobile relay station 170A. That is, the second mobile relay station 170B receives radio waves from the on-board relay station 140 and retransmits the radio waves to the first mobile relay station 170A, and receives radio waves from the first mobile relay station 170A and retransmits the radio waves to the on-board relay station 140. The second mobile relay station 170B may have substantially the same configuration as the mobile relay station 70 of the first communication support system 100A.

The at least one mover M1, M2, or M3 may include a third mover M3 on which a third mobile relay station 170C is mounted. The third mobile relay station 170C relays radio waves between the ground base station 60 and the on-board relay station 140. That is, the third mobile relay station 170C receives radio waves from the ground base station 60 and retransmits the radio waves to the on-board relay station 140, and receives radio waves from the on-board relay station 140 and retransmits the radio waves to the ground base station 60. The third mobile relay station 170C may have substantially the same configuration as the mobile relay station 70 of the first communication support system 100A.

The second communication support system 100B may include both or either of the second and third movers M2 and M3.

The relief ship 1 described above includes: a hull 11; an on-board relay station 140 mounted on the hull 11; at least one mover M1, M2, or M3 mounted on the hull 11 and movable to a place away from the hull 11; and a mobile relay station 170A, 170B, or 170C mounted on the mover M1, M2, or M3. The at least one mover M1, M2, or M3 includes a first mover M1 on which a first mobile relay station 170A is mounted, and the first mobile relay station 170A is configured to create a second wireless communication area A2 around the first mover M1, configured to receive a radio wave transmitted from a ground base station 60 and transmit the radio wave to a wireless terminal 50 located in the second wireless communication area A2, and configured to receive a radio wave transmitted from the wireless terminal 50 located in the second wireless communication area A2 and transmit the radio wave to the ground base station 60. The on-board relay station 140 is configured to relay radio waves between the ground base station 60 and the first mobile relay station 170A.

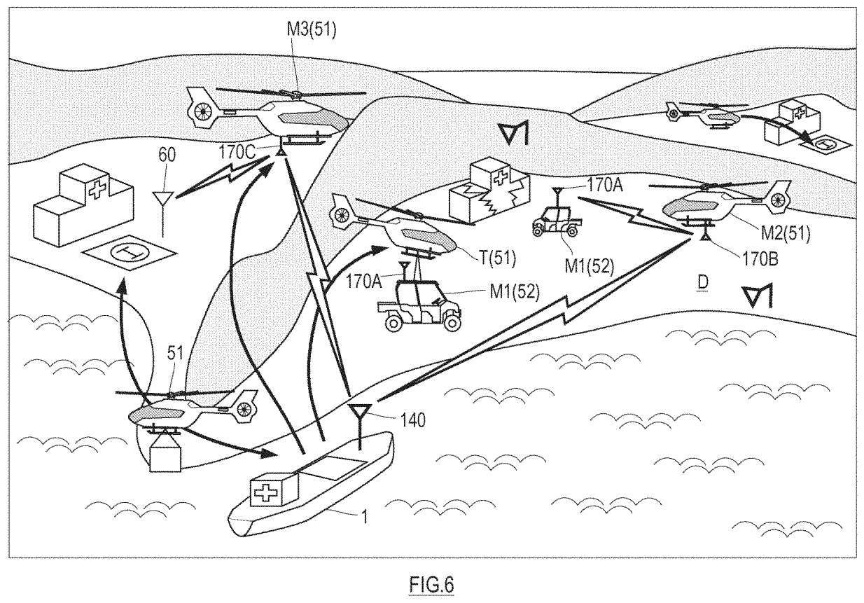

The relief ship 1 including the second communication support system 100B configured as described above is dispatched to, for example, a coastal region affected by a tsunami or an earthquake. In the example shown in FIG. 6, the relief ship 1 is at anchor off the coast of the disaster site D. At the disaster site D, the local communication infrastructure has been damaged, and the wireless communication function has been impaired. To address this situation, the first mover M1 is moved to the disaster site D. The first mover M1 is, for example, an off-road wheeled vehicle 52 capable of traveling on rough roads in the disaster site D. The relief ship 1 includes a transporter T that transports the first mover M1 from the ship to a location on the disaster site D (ground). In the example shown in FIG. 6, the helicopter 51 or small boat 53, for which the relief ship 1 is a base, serves as the transporter T.

In the above configuration, the ground base station 60 located away from the disaster site and the first mobile relay station 170A can exchange radio waves with each other through the on-board relay station 140. This makes it possible to deliver stable radio waves to the wireless terminal 50 located in the second wireless communication area A2 and improve the communication situation in the second wireless communication area A2.

Both the on-board relay station 140 and the first mobile relay station 170A are mobile. However, during exchange of radio waves, the on-board relay station 140 and the first mobile relay station 170A are at rest, and their positions can be determined. The position information can be used for purposes such as adjustment of the antennas in placement of the relay stations 140 and 170A.

In the relief ship 1 configured as described above, the second mover M2 may be moved from the relief ship 1 to a location between the relief ship 1 and the first mover M1, and the second mobile relay station 170B mounted on the second mover M2 may be used to relay radio waves between the on-board relay station 140 and the first mobile relay station 170A.

The relaying of radio waves between the on-board relay station 140 and the first mobile relay station 170A makes it possible, when there is an obstacle between the relief ship 1 and the first mover M1, to deliver the radio waves from the on-board relay station 140 to the first mobile relay station 170A (or vice versa) while avoiding the obstacle.

Likewise, in the relief ship 1 configured as described above, the third mover M3 may be moved from the relief ship 1 to a location between the relief ship 1 and the ground base station 60, and the third mobile relay station 170C mounted on the third mover M3 may be used to relay radio waves between the ground base station 60 and the on-board relay station 140.

The relaying of radio waves between the ground base station 60 and the on-board relay station 140 makes it possible, when there is an obstacle between the ground base station 60 and the relief ship 1, to deliver the radio waves from the ground base station 60 to the on-board relay station 140 (or vice versa) while avoiding the obstacle.

In the example shown in FIG. 6, the second and third movers M2 and M3 are the helicopters 51. However, each of the second and third movers M2 and M3 may be any one of the helicopters 51, wheeled vehicles 52, and small boats 53 for which the relief ship 1 is a base. There may be two or more second movers M2 or two or more third movers M3. In this case, radio waves are exchanged between the mobile relay stations 170B or between the mobile relay stations 170C.

Although the foregoing has described a preferred embodiment of the present disclosure, the scope of the present disclosure embraces modifications made to the details of the structure and/or function of the above embodiment without departing from the gist of the present disclosure. For example, the configurations described above can be modified as follows.

For example, the relief ship 1 may further include a satellite communication base station. The satellite communication base station includes a satellite antenna, a service antenna, a transceiver, a supervisory controller, and an electricity feeder (all of which are not shown). The satellite communication base station uses the satellite antenna to exchange radio waves, through the mediation of a communication satellite, with an earth base station connected to a communication network 21. The satellite communication base station uses the service antenna to exchange radio waves with the wireless terminal 50 located in or around the relief ship 1. The satellite communication base station may be further configured to transmit radio waves to the mobile relay station 70 mounted on the mover M moved from the relief ship 1 or the mobile relay station 170A mounted on the first mover M1.

### REFERENCE SIGNS LIST

1: relief ship
11: hull
19: wired communication network
21: communication network
40, 140: on-board relay station
50: wireless terminal
51: helicopter
52: wheeled vehicle
53: small boat
55: wired terminal
60: ground base station
70: mobile relay station
100A: first communication support system
100B: second communication support system
170A to 170C: mobile relay station
A1: first wireless communication area
A2: second wireless communication area
M, M1 to M3: mover
T: transporter

1. A relief ship comprising:
a hull;
an on-board relay station mounted on the hull to create a first wireless communication area on and/or around the hull;
at least one mover mounted on the hull and movable to a place away from the hull; and
a mobile relay station mounted on the mover, wherein
the on-board relay station is configured to receive a radio wave transmitted from a ground base station and transmit the radio wave to a wireless terminal located in the first wireless communication area and configured to receive a radio wave transmitted from the wireless terminal located in the first wireless communication area and transmit the radio wave to the ground base station, and
the mobile relay station is configured to relay radio waves between the on-board relay station and the ground base station.

2. The relief ship according to claim 1, wherein the at least one mover includes at least one helicopter, wheeled vehicle, or small boat.

3. The relief ship according to claim 1, wherein the on-board relay station is connected to a wired communication network located in the hull and is configured to exchange signals with a wired terminal connected to the wired communication network.

4. A relief ship comprising:
a hull;
an on-board relay station mounted on the hull;
at least one mover mounted on the hull and movable to a place away from the hull; and
a mobile relay station mounted on the mover, wherein
the at least one mover includes a first mover on which a first mobile relay station is mounted,
the first mobile relay station is configured to create a second wireless communication area around the first mover, configured to receive a radio wave transmitted from a ground base station and transmit the radio wave to a wireless terminal located in the second wireless communication area, and configured to receive a radio wave transmitted from the wireless terminal located in the second wireless communication area and transmit the radio wave to the ground base station, and
the on-board relay station is configured to relay radio waves between the ground base station and the first mobile relay station.

5. The relief ship according to claim 4, wherein
the at least one mover includes a second mover on which a second mobile relay station is mounted, and
the second mobile relay station is configured to relay radio waves between the on-board relay station and the first mobile relay station.

6. The relief ship according to claim 4 or 5, wherein
the at least one mover includes a third mover on which a third mobile relay station is mounted, and
the third mobile relay station is configured to relay radio waves between the on-board relay station and the ground base station.

7. The relief ship according to claim 4, wherein the at least one mover includes at least one helicopter, wheeled vehicle, or small boat.

8. The relief ship according to claim 4, wherein the on-board relay station is connected to a wired communication network located in the hull and is configured to exchange signals with a wired terminal connected to the wired communication network.

9. The relief ship according to claim 4, further comprising a transporter that transports the first mover from the relief ship to a location on the ground.
